(19) United States
(12) Patent Application Publication
(10) Pub. No.: US 2018/0368215 A1
(43) Pub. Date: Dec. 20, 2018

(54) ELECTROMAGNETIC WAVE HEATING DEVICE

(71) Applicant: IMAGINEERING, INC., Kobe (JP)

(72) Inventors: Yuji IKEDA, Kobe (JP); Seiji KANBARA, Kobe (JP); Minoru MAKITA, Kobe (JP); Yoshikazu SATOU, Kobe (JP); Kenichirou MITANI, Kobe (JP)

(21) Appl. No.: 15/749,347

(22) PCT Filed: Aug. 1, 2016
(86) PCT No.: PCT/JP2016/072515

§ 371 Date: Jul. 12, 2018

(30) Foreign Application Priority Data
Jul. 31, 2015 (JP) 2015-151600

(51) Int. Cl. H05B 6/68; H05B 6/72

(52) U.S. Cl. CPC H05B 6/687; H05B 2206/04; H05B 6/686; H05B 6/72

(57) ABSTRACT

To heat an object locally by automatically recognizing a shape of the object and emitting an electromagnetic wave based on the shape without enlarging a device size. An electromagnetic wave heating system comprises a heat chamber having a wall surface, in which an object is placed to be heated, a flat antenna arranged on the wall surface of the heat chamber and configured to emit the electromagnetic wave so as to heat the object inside the heat chamber, and a controller configured to control a movement of the flat antenna. The flat antenna comprises a plurality of antennas arranged in an array manner, and the controller detects a shape or a temperature distribution of the object based on a reflected power that is generated when the electromagnetic wave is emitted from the plurality of antennas, and determines a size of microwave supplied into each of the plurality of antennas based on a detection result thereof.

### TECHNICAL FIELD

The present invention relates to an electromagnetic wave heating system such as a microwave oven, specifically an electromagnetic wave heating system that heats food by using a plurality of array antennas for emitting an electromagnetic wave such as microwave, automatically recognizes a shape of an object, emits an electromagnetic wave based on the shape of the object, and thereby, heats the object.

### BACKGROUND ART

The electromagnetic wave heater is already known, which heats in suitable for the shape of an object and etc. by automatically recognizing the shape or the temperature distribution of the object such as food and, based on the result, controlling a directivity of the microwave irradiation antenna. For example, the microwave heater that calculates the temperature distribution of the object by the infrared sensor provided on the top part of heating room and, based on the result, emits the microwave having directivity into the object by using two rotation type antennas provided at the bottom surface side of the heating room, is disclosed in Patent Document 1.

### PRIOR ART DOCUMENTS

### Patent Document(s)

Patent Document 1: Unexamined Japanese patent application publication No. 2008-292088

### SUMMARY OF INVENTION

### Problem to be Solved by Invention

According to the microwave heater in Patent Document 1, it is difficult to measure the temperature distribution, for example, at the bottom and the side surfaces of the object, since the infrared sensor is arranged at the wall surface on the top surface side of the heating room. Accordingly, the temperature distribution measurement result cannot be utilized for controlling the electromagnetic wave irradiation from antennas arranged at the bottom and the side surfaces of the object.

Moreover, the directivity is given to the microwave emitted into the object by use of two rotation type antennas. However, there is a limitation for control of the irradiation-microwave-directivity only by two rotation type antennas.

### Means for Solving the Above Problems

The present invention is made from the above viewpoints.

### Effect of Invention

An electromagnetic wave heating system of the present invention comprises a heat chamber having a wall surface, in which an object is placed to be heated, a flat antenna arranged on the wall surface of the heat chamber and configured to emit an electromagnetic wave so as to heat the object inside the heat chamber, and a controller configured to control a movement of the flat antenna. The flat antenna comprises a plurality of antennas arranged in an array manner, and the controller detects a shape or a temperature distribution of the object based on a reflected power that is generated when the electromagnetic way is emitted from the plurality of antennas, and determines a size of microwave supplied into each of the plurality of antennas based on a detection result thereof.

### Effect of Invention

According to the present invention, an object can be heated locally by automatically recognizing a shape of the object and emitting an electromagnetic wave based on the shape thereof. Furthermore, a size reduction of an electromagnetic wave heating system can be achieved since a recognition of the object shape and heating can be performed not by using a plurality of elements such as an infrared sensor and a rotation antenna but by using one element, an array antenna.

### BRIEF DESCRIPTION OF FIGURES

FIG. 1 shows a schematic structural view of a microwave oven of a present embodiment.

FIG. 2 shows the schematic structural view of a flat antenna regarding the microwave oven of the present embodiment.

FIG. 3 shows a front view of the flat antenna of the present embodiment.

FIG. 4 shows the schematic structural view of a switcher of the present embodiment.

### EMBODIMENTS FOR IMPLEMENTING THE INVENTION

In below, embodiments of the present invention are described in details based on figures. Note that, following embodiments are essentially preferable examples, and the scope of the present invention, the application, or the use is not intended to be limited.

### First Embodiment

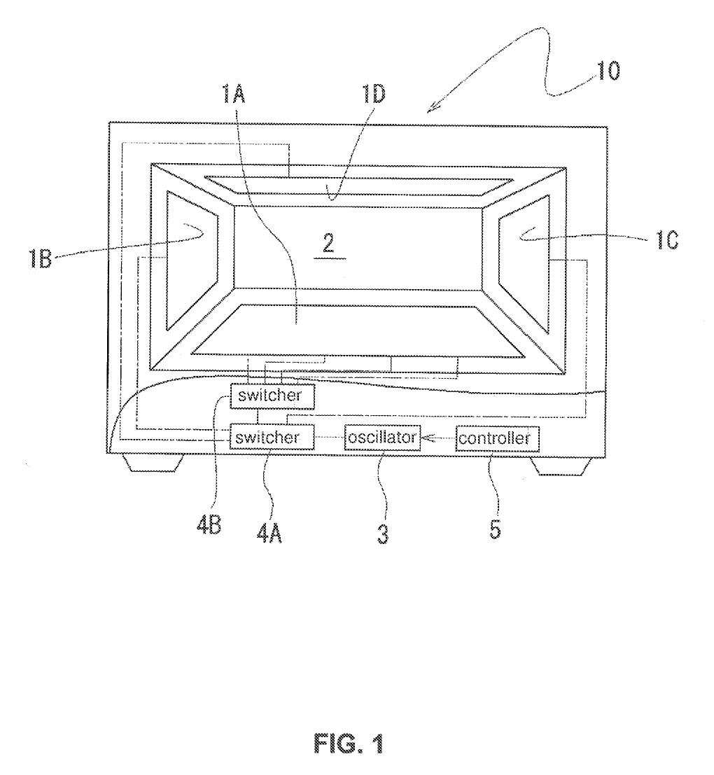

Referring to FIG. 1, a microwave oven 10, one example of an electromagnetic wave heating system of the present invention, comprises a heat chamber 2 configured to store an object, flat antennas 1A to 1D arranged on top, bottom, left, and right wall surfaces of the heat chamber, an oscillator 3 configured to generate a microwave, a switcher 4A configured to switch a supply destination of microwave inputted from the oscillator 3, a switcher 4B configured to switch a supply destination of microwave inputted from the switcher 4A, a controller 5 configured to control the oscillator 3 and the switcher 4 (the switcher 4A and the switcher 4B), and a coaxial line 6 that connects each switcher 4 with each flat antenna 1. The switcher 4A selects one of the switcher 4B, the flat antennas 1B, 1C, 1D or multiple of them as a microwave output destination. Moreover, as described below, the respective flat antennas 1 are formed to be arranged of a plurality of small sized antennas 11 in an array manner. Then, the switcher 4B selects small sized antenna 11 inside the flat antennas 1A as the microwave output destination.

Each flat antenna 1A to 1D is arranged to a corresponding wall surface made of metal via an insulator such as ceramics having heat resistance characteristic. Moreover, a mount table on which an object is put, is also formed by an insulator such as ceramics having the heat resistance characteristic, and provided on the flat antenna 1A that is provided at the bottom wall surface side.

Moreover, the controller 5 detects a shape or a temperature distribution of the object (food) put on the mount table by use of a reflected power that is generated when the microwave is emitted from each of small sized antennas 11 of the flat antenna 1A, and based on the detection result, defines a size of microwave supplied into each of small sized antennas 11.

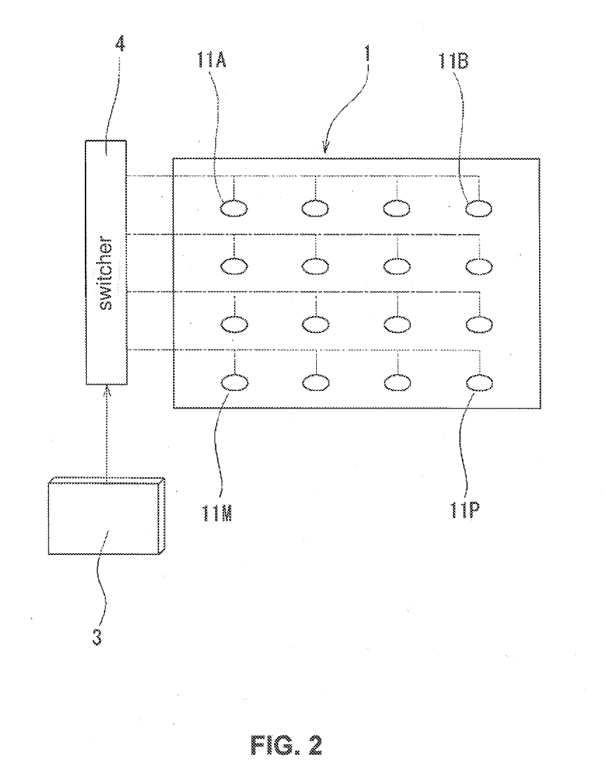

Referring to FIG. 2, regarding each flat antenna 1, sixteen small sized antennas 11A to 11P are arranged by four column×four row in an array manner. With regard to the flat antenna 1A, microwave is series-supplied from the switcher 4B in every line or row. For example, a first output terminal of the switcher 4B is connected to four small sized antennas 11A to 11D arranged at the first row of the flat antenna 1A, and a second output terminal of the switcher 4B is connected to four small sized antennas 11E to 11H arranged at the second row of the flat antenna 1A. In other word, a distance from each antenna 11 existed in the same row to the switcher is different from each other. Since a length from the oscillator 3 to each antenna 11 is different from each other, an appropriate operational frequency is different from each other. By seeing the above from the counter side viewpoint, a microwave frequency provided to the flat antenna 1 is changed, and the small sized antenna 11 to be “ON” inside the flat antenna 1 can be switched.

When an object, i.e., food is put on the mount table of the flat antenna 1A, the microwave emitted from respective antennas 11 of the flat antenna 1A is partially reversed to the flat antenna 1A by reflection at the object and etc. Accordingly, the shape of the object can also be recognized automatically by monitoring the reflected power size by the controller 5.

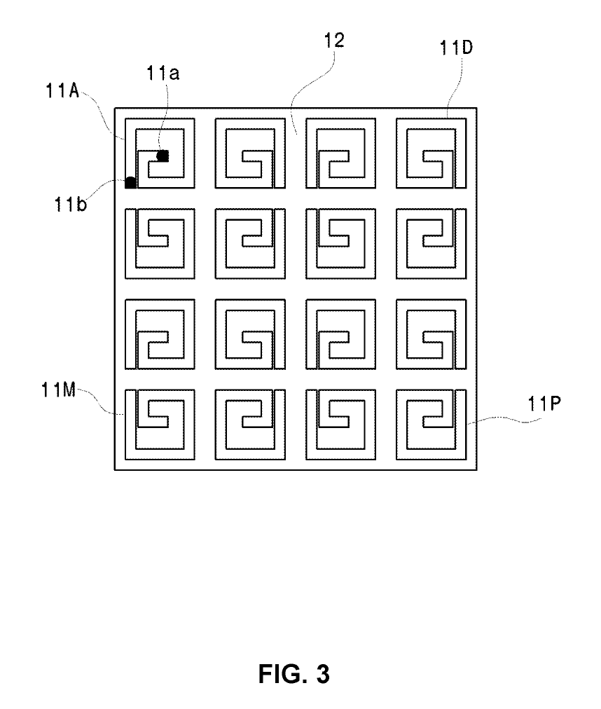

Referring to FIG. 3, with regard to the flat antenna 1, sixteen metal patterns in spiral manner are formed on the surface of a substrate 12 with insulation characteristics such as ceramics. Each of metal patterns forms one small sized antenna 11.

Four power feed points configured to receive microwave from the switcher 4B are formed at a second substrate on the back surface side (not illustrated). Further, referring to FIG. 2, a metal pattern is formed on the surface so as to deliver the microwave from four power feed points to each small sized antenna 11 in every row of the flat antenna 1.

Each small sized antenna 11 is formed spirally at the center of a power receiving end 11a inputted of the microwave, and formed such that a distance from the power receiving end 11a to an opening end 11b becomes approximately ¼ wavelength of microwave. Moreover, a through hole is formed at a position of the power receiving end 11a of each small sized antenna 11 of the substrate 12. A via is filled with at the through hole, and the metal pattern of the first substrate 12 is connected to the metal pattern of the second substrate 13 through the via.

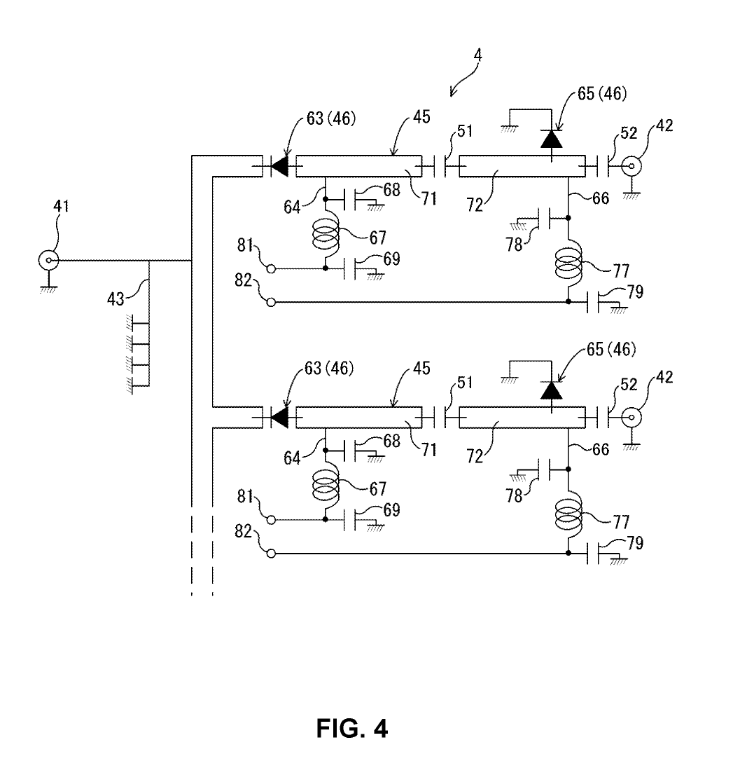

Referring to FIG. 4, the switcher 4 comprises an input terminal 41 (an input part), a plurality of output terminals 42 (output parts), and a plurality of branch transmission lines 45 (transmission parts). The microwave outputted from the oscillator 3 is inputted into the input terminal 41. The microwave outputted from the respective output terminals 42 is connected to the power feed points 14 of each flat antenna 1. The branch transmission line 45 is provided in correspondence to the output terminal 42. The input terminal 41 is grounded via a ground line 43 at the input side.

Each branch transmission line 45 comprises a switching means 46 for switching an “ON” state that allows for microwave passage and an “OFF” state that do not allow for microwave passage. Each switching means 46 includes a transmission-side diode 63 and a ground-side diode 65 that are constituted of, for example, PIN diode. Each branch transmission line 45 is provided with a capacitor 51 and a capacitor 52 in this order, seen from the input terminal 41 side.

In the transmission-side diode 63, a “cathode” is connected to the input terminal 41 side, and an “anode” is connected to a first strip line 71. A bias-line 64 is provided with at the “anode” side of the transmission side diode 63 (at the first strip line 71), and the other end of the bias-line 64 is connected to a signal input part 81. The capacitor 51 is connected at the output terminal 42 side of the first strip line 71. A second strip line 72 is connected at the output terminal 42 side of the capacitor 51.

The “cathode” is grounded at the ground-side diode 65, and the “anode” is connected to the second strip line 72. A bias-line 66 is provided at the “anode” side of the ground-side diode 65 (at the second strip line 72), and the other end of the bias-line 66 is connected to a signal input part 82.

An inductor 67 is provided at the bias-line 64 at the transmission side, and both ends of the inductor 67 are grounded through capacitors 68 and 69. An inductor 77 is provided at the bias-line 66 at the ground side, and both ends of the inductor 77 are grounded through capacitors 78 and 79.

An input side ground line 43 is branched into a plurality of branch ground lines. An electrical length up to the oscillator 3 can be adjusted by selecting the branch ground line 43 to be eliminated off. Accordingly, an adjustment with respect to circuit impedance variation caused by an assembly tolerance and parts variability during manufacturing can be performed at also final stage of manufacturing.

With respect to the branch transmission line 45a in correspondence to the output terminal 42 for outputting the microwave, a positive bias voltage is applied to the signal input part 81 of the bias-line 64 at the transmission side, while, a negative bias voltage is outputted to the signal input part 82 of the bias-line 66 at the ground side. Thereby, the transmission side diode 63 to which forward-bias is applied, is conducted through at the output side transmission line 45a, and the ground side diode 65 to which reverse-bias is applied, is blocked.

With respect to the branch transmission line 45b in correspondence to the output terminal 42 from which the microwave is not outputted, the negative bias voltage is applied to the signal input part 81 of the bias line 64 at the transmission side, while, the positive bias voltage is outputted to the signal input part 82 of the bias line 66 at the ground side. Thereby, the transmission side diode 63 to which reverse-bias is applied, is blocked at non-output side transmission line 45b, and the ground side diode 65 to which forward-bias is applied, is conducted through.

From these above results, since the output side transmission line 45a is conducted through and the non-output side transmission line 45b becomes blocked when seen from the input terminal 41, the microwave inputted into the input terminal 41 is outputted from the output terminal 42 via the output side transmission line 45a.

### INDUSTRIAL APPLICABILITY

As illustrated as above, the present invention is effective to an electromagnetic wave heating system such as a microwave oven.

### NUMERAL SYMBOLS EXPLANATION

1. Flat Antenna
2. Heat Chamber
3. Oscillator
4. Switcher
5. Controller
6. Coaxial Line
11. Small-sized Antenna
12. First Substrate
13. Second Substrate
14. Power Feed Point

1. An electromagnetic wave heating system comprising:
a heat chamber having a wall surface, in which an object is placed to be heated;
a flat antenna arranged on the wall surface of the heat chamber and configured to emit an electromagnetic wave so as to heat the object inside the heat chamber; and
a controller configured to control a movement of the flat antenna,
wherein
the flat antenna comprises a plurality of antennas arranged in an array manner, and
the controller detects a shape or a temperature distribution of the object based on a reflected power that is generated when the electromagnetic wave is emitted from the plurality of antennas, and determines a size of microwave supplied into each of the plurality of antennas based on a detection result thereof.

2. The electromagnetic wave heating system according to claim 1, further comprises a switcher configured to select an antenna among the plurality of antennas,
wherein the switcher comprises an input part configured to receive the electromagnetic wave, and a plurality of output parts configured to output the electromagnetic wave, and the controller performs to control the switcher based on the detection result.
